(19) United States
(12) Patent Application Publication
(10) Pub. No.: US 2004/0008257 A1
(43) Pub. Date: Jan. 15, 2004

(54) Monitoring service process using communication network

(76) Inventor: Jung-Hwan Kim, Elk Grove Village, IL (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/613,464

(22) Filed: Jul. 3, 2003

(30) Foreign Application Priority Data
Jul. 11, 2002 (KR) 10-2002-0040182

(51) Int. Cl. H04N 7/18

(52) U.S. Cl. 348/152

(57) ABSTRACT

Disclosed is a monitoring service process using a communication network, in which monitoring data from a monitoring zone is transmitted to a monitoring center using a communication network and is stored therein. After stored monitoring data is transmitted to a place specified when an event occurs. The monitoring data can be analyzed. This process includes registering the monitoring sites with the monitoring service center; transmitting monitoring data to the monitoring service center; receiving the monitoring data from the monitoring sites, classifying the monitoring data according to the monitoring sites and storing the classified monitoring data; and notifying an event's occurrence to a manager of a corresponding monitoring site and transmitting the monitoring data to a place specified when an event occurs. Since the monitoring data is stored in a secure place rather than in the actual monitoring spot, breakage or destruction of the monitoring data can be prevented.

### BACKGROUND OF THE INVENTION

1. Field of the Invention

The present invention relates to a monitoring service process using a communication network, in which monitoring data from a image monitoring system installed in a monitoring zone is transmitted to a monitoring center using a communication network and is stored therein, after which the stored monitoring data is transmitted to a place specified when an event occurs, so that the monitoring data can be analyzed.

2. Description of Related Art

A conventional unmanned guard system, which has been used for monitoring any zone of concern, is provided with an unmanned camera, an industrial television or a closed circuit television (hereinafter abbreviated as CCTV) for photographing a place to be monitored and transmitting the photographed images. That is, the monitoring images, which are imaged by the monitoring camera installed in the monitoring zone, are displayed on a monitoring screen in real time and, in addition, are continually recorded by a videocassette recorder or a videodisc recorder connected to the monitoring camera. If an event occurs, therefore, a cause of the event can be deduced or a criminal can be identified by analyzing a tape or a disc on which the recording device has recorded the monitoring images.

Such a conventional monitoring system, however, has a problem in that the cause of the event cannot be analyzed in a case when the tape or disc is destroyed by a trespasser or fire.

### SUMMARY OF THE INVENTION

Accordingly, the present invention has been created in order to solve the above-mentioned problem occurring in the prior art, and an object of the present invention is to provide a monitoring service process using a communication network, in which monitoring image data is periodically transmitted from a monitoring site to a monitoring center and is stored therein, and then the stored monitoring data corresponding to a predetermined amount of time is transmitted to a place specified such as a police station, etc. when an event occurs, so that a cause of the event can be analyzed.

To accomplish this object, there is provided a monitoring service process, in which monitoring sites and a monitoring service center are connected to each other via a communication network so as to have the custody of monitoring data, in accordance with the present invention, the process comprising the steps of: registering the monitoring sites with the monitoring service center; transmitting monitoring image data and sensing signals of monitoring zones, which are imaged and detected by the respective monitoring sites, to the monitoring service center; receiving the monitoring data transmitted from the registered monitoring sites, classifying the monitoring data according to the monitoring sites and storing the classified monitoring data in the monitoring service center; and notifying an event's occurrence to a manager, set at the above registration, of a corresponding monitoring site and transmitting the monitoring image data of a predetermined amount to a place specified when an event occurs in any of the monitoring sites.

In this monitoring service process, it is preferred that each monitoring site includes monitoring cameras for monitoring corresponding zones, a trespass-sensing sensor for detecting a lawless person's trespass upon the monitoring zone, a fire-sensing sensor for detecting a fire breaking out and a monitoring client for forming sensing signals inputted from the respective sensing sensors and monitoring data forwarded from the monitoring camera into a preset communication packet and transmitting the communication packet to a monitoring server through the communication network.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view showing construction of a network in accordance with the present invention;

FIG. 2 is a schematic view showing construction of a monitoring site in FIG. 1;

FIG. 3 is a flowchart showing overall service procedures in accordance with the present invention;

FIG. 4 is a flowchart showing procedures performed by the monitoring site in accordance with the present invention;

FIG. 5 is a flowchart showing procedures performed by a monitoring service center in accordance with present invention; and

FIG. 6 is a flowchart showing procedures where a manager is connected to the monitoring service center to confirm monitoring images.

### DESCRIPTION OF THE PREFERRED EMBODIMENTS

Hereinafter, preferred embodiments of the present invention will be described in detail with reference to the accompanying drawings.

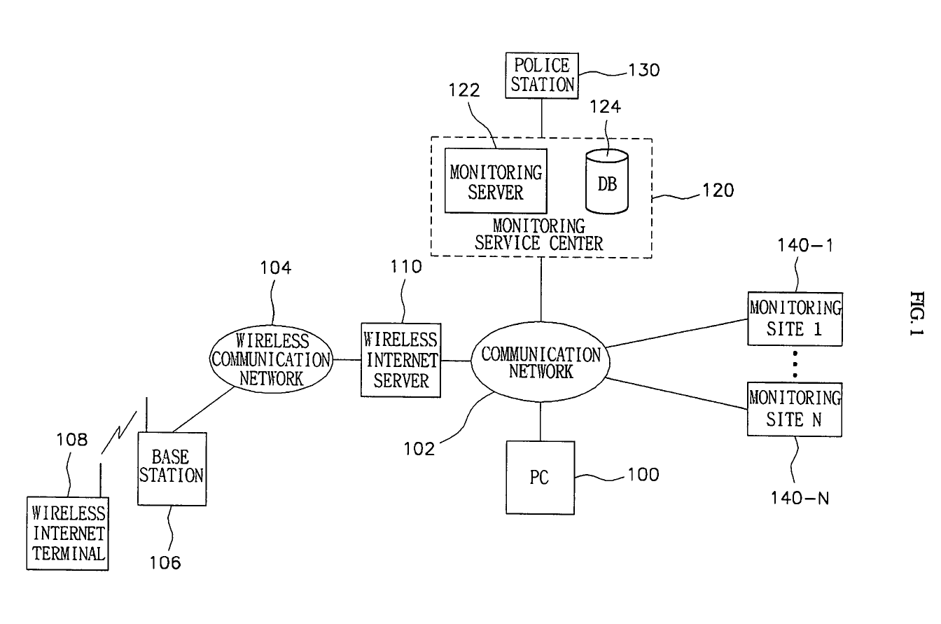

FIG. 1 shows a schematic construction of a network in accordance with the present invention.

Referring to FIG. 1, the network according to the invention comprises a PC terminal 100, a communication network 102, a wireless network 104, a base station 106, a wireless internet terminal 108, a wireless network server 110, a monitoring service center 120, a police station 130 and a first to an Nth monitoring site 140-1 to 140-N.

The PC terminal 100, intended for enabling a manager of any monitoring sites 140-1 to 140-N to remotely confirm monitoring images, is provided with a web browser and a multi media player in use and is connected to the monitoring service center 120 via the communication network 102. The wireless internet terminal 108 is a cellular phone, a PDA (Personal Digital Assistant) and the like which the manager of any monitoring sites 140-1 to 140-N carries and can be connected to the wireless internet server 110 via the base station 106 and the wireless communication network 104. The wireless internet server 110 serves to provide a wireless internet protocol to the wireless internet terminal 108 and connect the wireless communication network to a general communication network.

The monitoring service center 120, including a monitoring server 122 and a database 124, receives monitoring data transmitted from the respective monitoring sites 140-1 to 140-N, classifies the data according to the monitoring sites 140-1 to 140-N and stores it together with time information. When an event occurs, for example, when any of the monitoring sites 140-1 to 140-N senses a fire or a trespass, the monitoring service center 120 not only notifies the manager of the corresponding monitoring site 140-1 to 140-N of the event's occurrence by way of communication means, but also transmits the corresponding monitoring data to the police station 130 or a guard service company. Additionally, if the manager of the registered monitoring site 140-1 to 140-N is connected thereto through the PC terminal 100 or the wireless internet terminal 108, the monitoring service center 120 transmits monitoring images of the corresponding monitoring sites 140-1 to 140-N to the terminal 100 or 108, thereby allowing home or mobile monitoring. At this time, the monitoring service center 120 preferably has a search function that permits the manager to confirm the monitoring images in real time as well as to confirm the monitoring data of a previous desired time period.

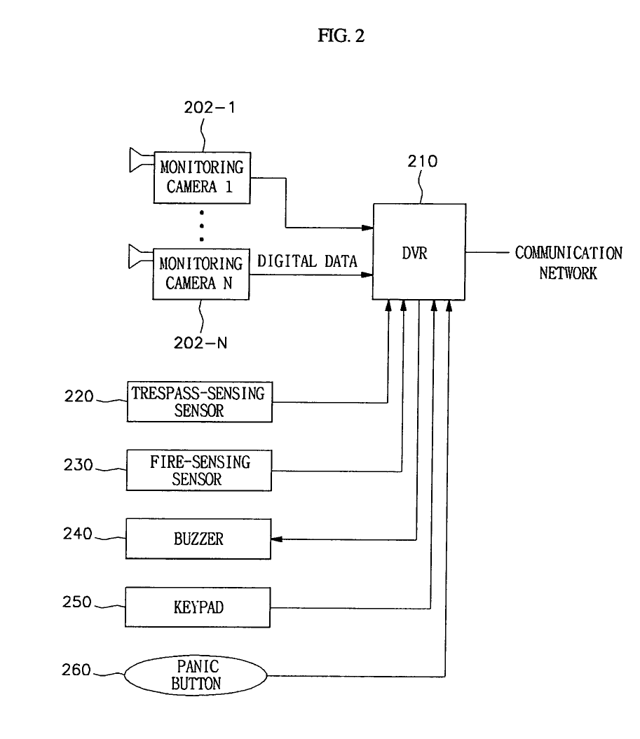

FIG. 2 shows a schematic construction of the monitoring site in FIG. 1.

Referring to FIG. 2, each monitoring site 140-1 to 140-N includes N monitoring cameras 202-1 to 202-N for monitoring corresponding zones, a digital video recording system (DVR) 210 for self-recording video output of the monitoring cameras 202-1 to 202-N, forming sensing signals inputted from the respective sensing sensor 220, 230 and monitoring data forwarded from the monitoring cameras 202-1 to 202-N into a preset communication packet and then transmitting the communication packet via the communication network 102, a trespass-sensing sensor 220 for detecting anybody's trespass upon the monitoring zone, a fire-sensing sensor 230 for detecting a fire breaking out, a buzzer 240 for sounding an alarm, a keypad 250 for key inputting and a panic button 260 for calling for help to a guard service company or a police station in an emergency.

The monitoring cameras 202-1 to 202-N image the monitoring zones and then provide video signals to the DVR 210.

The DVR 210 sets operations of the monitoring site 140-1 to 140-N in accordance with the key inputting by the keypad 250, packetizes monitoring data forwarded from the respective monitoring cameras 202-1 to 202-N and sensing signals forwarded from the trespass-sensing sensor 220 and the fire-sensing sensor 230 in a certain format, and transmits them to the monitoring server 122. At this time, the video data of the monitoring cameras 202-1 to 202-N is preferably compressed prior to its transmission according to a compression algorithm such as MPEG, etc. because the video data is generated in a large quantity. Also, the DVR 210 controls entire operations of the monitoring site 140-1 to 140-N and, when an event such as a trespass or a fire occurs, transmits this fact to the monitoring server 122 and simultaneously sounds the buzzer 240 so as to let the manager know the event's occurrence. If the panic button 260 is pushed, the monitoring image data stored in the DVR 210 is transmitted to the monitoring server 122. The DVR 210 needs a communication line for transmitting the monitoring data to the monitoring server 122 through the communication network 102. Various types such as a T1 exclusive line type, an ADSL (Asymmetric Digital Subscriber Line) type, a WLL (Wireless Local Loop) type, a PSTN (Public Switched telephone Network) type, a cable network type and the like may be used as such a communication line.

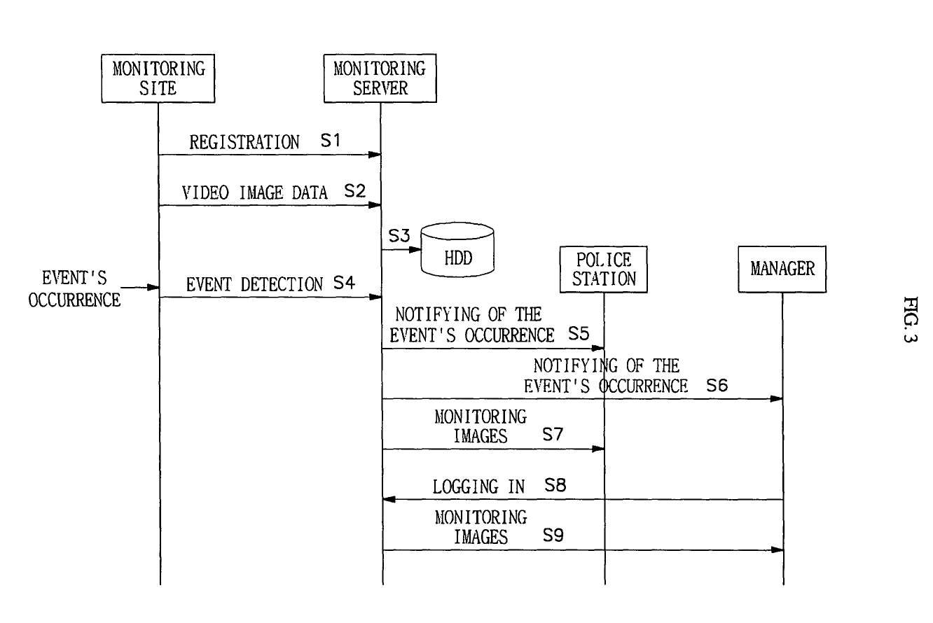

FIG. 3 is a flowchart showing overall service procedures in accordance with the present invention wherein procedures between the monitoring site 140-1 to 140-N, the monitoring server 122, the police station 130 and the manager are illustrated.

Referring to FIG. 3, the monitoring site 140-1 to 140-N is first registered with the monitoring server 122 after the monitoring site 140-1 to 140-N is established (S1). In this case, the registration items includes an IP address of the monitoring site 140-1 to 140-N, identification and communication of the monitoring site manager, an IP address of a place to which the monitoring data will be transmitted when an event occurs, the quantity of monitoring data to be transmitted and so forth.

Following the registration, a monitoring site 140-1 to 140-N self-stores video image data of the monitoring zone, which is imaged by the monitoring cameras 202-1 to 202-N, and simultaneously forms the video image data into a preset format and transmits it to the monitoring server 122 (S2). The format of data transmitted from the monitoring site 140-1 to 140-N to the monitoring server 122 includes a header, a source IP, a destination IP, video data, sensing data from the respective sensors, CRC (Cyclic Redundancy Check) and so on.

The monitoring server 122 analyzes the monitoring data received from the respective monitoring sites 140-1 to 140-N and cumulatively stores the video data together with time information in a storage section (HDD; Hard Disc Drive) of the corresponding monitoring site 140-1 to 140-N (S3). At this time, it is preferred that the video data is stored in a first-in first-out manner by the day or by the week according to the storage capacity and, if necessary, previous data can be backed up with a disc, etc. and be separately stored.

In this way, the monitoring data is classified according to the monitoring sites 140-1 to 140-N and is stored in the monitoring server 122. Then, if an event's occurrence is forwarded from any of the monitoring sites 1401- to 140-N, the monitoring server 122 notifies the police station or the manager whose registration was recorded of the event's occurrences and simultaneously transmits the monitoring data of the corresponding site 140-1 to 140-N to the police station 130 or the like (S4 to S7). In this case, it is preferred to transmit the monitoring data starting from a point one hour before the event occurred up to the time of the event's occurrence, but the monitoring data of any desired time period can be taken, if necessary, because the monitoring data of all time periods is stored in the monitoring server 122.

If the event's occurrence is notified to the manager, the manager can receive and confirm the monitoring images via the PC 100 and the terminal 108 after being connected to the monitoring service center 120 and logging in (S8, S9).

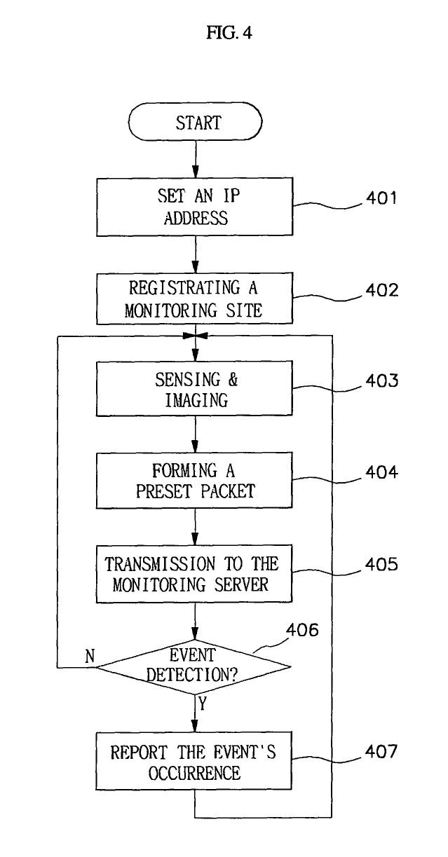

FIG. 4 is a flowchart showing procedures performed by the monitoring site.

Referring to FIG. 4, each monitoring site 140-1 to 140-N is endowed with an IP address and sets it on the DVR 210 (401). That is, a plurality of monitoring sites 140-1 to 140-N, which the monitoring service center 120 manages, are identified by their own IP address and all the monitoring data are always transmitted with the IP addresses, which makes it possible to distinguish which monitoring site 140-1 to 140-N transmits the monitoring data.

Thereinafter, a monitoring site 140-1 to 140-N is registered with the monitoring service center 120 so as to be provided with the monitoring center's service (402). At this time, an IP address of said monitoring site 140-1 to 140-N, identification and communication of the monitoring site manager, an IP address of a place to which the monitoring data will be transmitted when an event occurs, the quantity of monitoring data to be transmitted and so forth are registered.

After the registration, the respective sensors 220, 230 of said monitoring site 140-1 to 140-N creates sensing signals according to the control of the DVR 210 to provide the sensing signals to the DVR 210, and the monitoring camera 202 images the monitoring zone and provides the imaged monitoring data to the DVR 210 so that the data can be recorded in the DVR 210 (403).

The DVR 210 compresses the digital video data transmitted from the monitoring camera 202 according to an MPEG algorithm and forms the compressed data and the sensing signals forwarded from the respective sensors 220, 230 into a preset format and thus a preset packet (404). The transmission packet thus produced is periodically transmitted to the monitoring server 122 in accordance with a communication protocol.

When the sensing sensors 220, 230 or the panic button 260 detect a trespass, a fire breaking out and the like, the DVR 210 issues an alarm according to the event detection and reports the event's occurrence to the monitoring server 122 (406, 407).

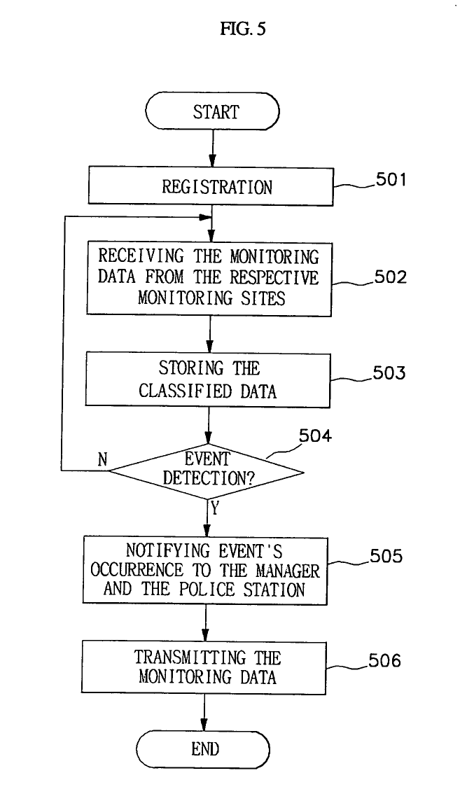

FIG. 5 is a flowchart showing procedures performed by the monitoring service center. Referring to FIG. 5, the monitoring service center 120 makes registration for the monitoring site 140-1 to 140-N to be managed (501). The registration information of the respective monitoring sites 140-1 to 140-N is stored and managed in a tabular form in a corresponding client information database.

Next, the monitoring service center 120 receives the monitoring data from the respective monitoring sites 140-1 to 140-N, classifies the data according to the monitoring sites 140-1 to 140-N and stores the classified data therein (502, 503). In this way, the receiving and storing operations of the monitoring data are continually performed with the passage of time, and older data having a certain elapsed time period is preferably backed up with a disc, etc. and is stored off-line.

If an event's occurrence is notified from the monitoring site 140-1 to 140-N, the monitoring service center 120 notifies the event's occurrence to the manager set at the registration and the police station 130, and then transmits the monitoring data of a predetermined quantity to the IP specified (IP of the police station) (504 to 506).

The police station or the guard service company inspects a cause of the event by reproducing the transmitted monitoring images and, if necessary, downloads and analyzes the monitoring data of other time periods after being connected to the monitoring service center and logging in.

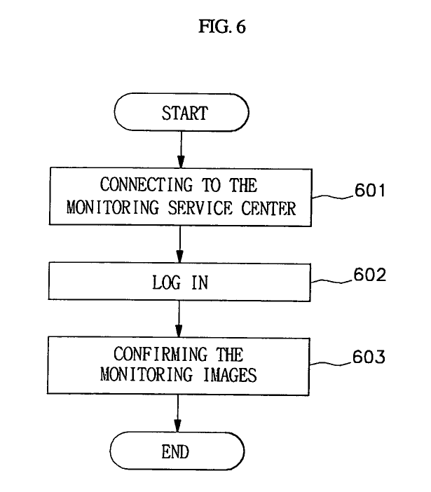

FIG. 6 is a flowchart showing procedures where the manager is connected to the monitoring service center to confirm monitoring images.

Referring to FIG. 6, the manager of the monitoring site 140-1 to 140-N registered with the monitoring service center 120 can be connected to the monitoring service center 120 and confirm the monitoring images of his own monitoring site 140-1 to 140-N at any time desired.

In a case when an event's occurrence is notified to the manager or the manager wants to confirm the monitoring images, the manager is connected to the monitoring center 120 using the PC 100 or the terminal 108 and inputs his ID and password for logging in (601, 602).

After the logging in, the current monitoring image of the monitoring site 140-1 to 140-N is displayed on the PC or the terminal 108 and an input window for search appears (603). If the manager wants to confirm the monitoring image of another time period after the confirmation of the current image, he inputs the desired time period and then clicks a search button. If so, the monitoring server 122 calls the monitoring data of the corresponding time period and enables the manager to confirm that data.

In the monitoring service process of the present invention as described above, the monitoring center receives the monitoring data of the respective monitoring sites in a lump, classifies the data according to the monitoring sites and stores the classified data therein. When an event occurs, the monitoring service center not only notifies the event's occurrence to the manager of the corresponding monitoring site, but also transmits the monitoring data to the police station, the guard service company or the like so as to inspect a cause of the event. In particular, since the monitoring data is stored in a secure place at the monitoring service center rather than in the actual monitoring spot, breakage or destruction by fire of the monitoring data can be prevented.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed:

1. A monitoring service process, in which monitoring sites and a monitoring service center are connected to each other via a communication network so as to have the custody of monitoring data, the process comprising the steps of:
registering the monitoring sites with the monitoring service center;
transmitting monitoring image data and sensing signals of monitoring zones, which are imaged and detected by the respective monitoring sites, to the monitoring service center;
receiving the monitoring data transmitted from the registered monitoring sites, classifying the monitoring data according to the monitoring sites and storing the classified monitoring data in the monitoring service center; and
notifying an event's occurrence to a manager, set at the above registration, of a corresponding monitoring site and transmitting the monitoring image data of a predetermined amount to a place specified when an event occurs in any of the monitoring sites.

2. A monitoring service process according to claim 1, wherein each monitoring site includes monitoring cameras for monitoring corresponding zones, a trespass-sensing sensor for detecting a lawless person's trespass upon the monitoring zone, a fire-sensing sensor for detecting a fire breaking out and a monitoring client for forming sensing signals inputted from the respective sensing sensors and monitoring data forwarded from the monitoring camera into a preset communication packet and transmitting the communication packet to a monitoring server through the communication network.

3. A monitoring service process according to claim 1, wherein the monitoring service center includes a web server and a database, and stores and manages an IP address of the monitoring site, identification and communication of the monitoring site manager, an IP address of a place to which the monitoring data will be transmitted when an event occurs, the quantity of monitoring data to be transmitted and so forth inputted at the registration.

4. A monitoring service process according to claim 1, wherein the manager can confirm desired monitoring images after being connected to the monitoring service center and logging in.
